(19) United States
(12) Patent Application Publication
(10) Pub. No.: US 2015/0192179 A1
(43) Pub. Date: Jul. 9, 2015

(54) DUAL-WET-CLUTCH TRANSMISSION

(71) Applicant: BorgWarner Inc., Auburn Hills, MI (US)

(72) Inventor: Jean Armiroli, Beaulieu Sur Mer (FR)

(21) Appl. No.: 14/408,993

(22) PCT Filed: Jun. 21, 2013
(86) PCT No.: PCT/US2013/046978

§ 371 Date: Dec. 18, 2014

(30) Foreign Application Priority Data
Jun. 26, 2012 (FR) 1256057

(51) Int. Cl. F16D 48/06; F16D 48/02; F16D 21/06

(52) U.S. Cl. CPC F16D 48/062; F16D 21/06; F16D 25/14; F16D 2021/0653; F16D 2021/0661; F16D 2500/1027; F16D 2500/30421; F16D 2500/30426; F16D 2500/3024

(57) ABSTRACT

Dual-wet-clutch (8, 9) transmission (3) for a vehicle gearbox, said dual-clutch (8, 9) transmission (3) being coupled to a drive shaft (12) and being able to receive the torque from the drive shaft (12), also including a hydraulic circuit fed by a pump (20) supplying the pressurized fluid, means for controlling the movement of the clutches (8, 9), belonging to the hydraulic circuit. The means for controlling the movement of the clutches (8, 9) include a proportional flow rate valve (14, 15) for each clutch (8, 9) providing at the output (S1) a hydraulic pressure injected into the clutch (8, 9) against a return force exerted on the clutch (8, 9) by spring means (27, 28), said proportional flow rate valve (14, 15) being closed-loop controlled to adjust the pressure in the output (S1).

The present invention relates to a dual-wet-clutch transmission for a vehicle gearbox.

This type of dual-wet-clutch transmission is already used in vehicle gearboxes, along with other types of transmission such as automatic and manual transmissions.

In general, such a transmission is coupled to a drive shaft, the intention being to transmit a torque coming from the drive shaft to a system of gears in the gearbox.

A traditional multi-speed, dual-clutch gearbox uses a combination of two friction clutches and several synchronizer gears to effect the power changes by alternating between one clutch and the other, the synchronizers being selected to obtain forward and reverse gear ratios.

The gearbox is controlled by a hydraulic control system that includes a plurality of solenoid valves in fluid communication with the clutches and the synchronizers.

The selective activation of the solenoid valves using control electronics enables a pressurized fluid to activate at least one clutch and one synchronizer to engage the required gear ratio in the gearbox.

In the case of the present invention, the dual-clutch transmission is wet, which means that the clutch components, in particular the clutch disks, are immersed in a lubricating fluid such as to reduce the friction and to limit the heat generated and therefore to cool the disks. Indeed, when the clutch disks are under pressure, there is an initial friction between the disks and an initial transmission of torque from the drive shaft to the gears, resulting in a temperature increase. Cooling the disks makes it possible to increase the friction time thereof without damaging them, thereby making gear changes smoother. In the case of a dry clutch, transition has to be quick so as not to overheat the disks and reduce the service life thereof, and the transmission of torque is therefore more abrupt, which is not desirable.

Clutches are currently controlled by proportional pressure valves in a low-pressure hydraulic circuit, i.e. a pressure of less than 20 bars. These valves determine an output pressure as a function of the input current applied thereto, and this output pressure induces a force applied to the clutch. This type of valve is subject to relatively significant hydraulic leaks, but the use thereof is designed to control the clutches of a low-pressure dual-clutch transmission (<20 bars).

The future is in high-pressure dual-wet-clutch transmissions, i.e. at a pressure greater than 20 bars, because the high pressure makes it possible to:
reduce the sections of the parts while generating an equivalent force, resulting in an economic advantage in terms of component cost;
reducing hydraulic response times and therefore a fortiori the response times of the transmission system.

However, high pressure has the drawback of increasing hydraulic leaks.

These proportional pressure valves are not suitable for a high-pressure dual-clutch transmission (>20 bars) because they generate too many leaks and are too sensitive to vibrations on account of the design thereof This introduces an instability into the system that is not desirable because the torque transmission becomes abrupt. These valves are operated in open loop, i.e. without closed-loop control, and they have no direct feedback concerning vibration and leaks.

Furthermore, the presence of vibrations in the valve significantly increases leaks in addition to the high pressure, and the pump that generates the pressure in the system has to operate too often, which reduces the overall efficiency of the system.

The present invention is therefore intended to enable control of high-pressure dual-wet-clutch transmission, without generating vibrations in the system, and smooth transmission of the torque, i.e. in the changes between gear ratios, to ensure an enjoyable driving experience for the driver and good overall efficiency of the system. To achieve these objectives, the management of vibrations, a low response time in the valves to fill the clutches when they are active, and management of leaks in the transmission system are essential.

To do so, the invention relates to a transmission including:
a first wet clutch that is movable between a free position and an engaged position with the drive shaft to actuate a first gear arrangement in the gearbox;
a second wet clutch that is movable between a free position and an engaged position with the drive shaft to actuate a second gear arrangement in the gearbox;
a hydraulic circuit fed by a pump supplying the pressurized fluid;
means for controlling the movement of the clutches, belonging to the hydraulic circuit.

The invention is primarily characterized in that said means for controlling the movement of the clutches include a proportional flow rate for each clutch outputting a hydraulic pressure injected into the clutch against a return force exerted on the clutch by spring means, said proportional flow rate being closed-loop controlled to adjust the output pressure.

The benefit of using a proportional flow rate instead of a proportional pressure valve lies in the internal structure of the valve, which is more robust, more simple and less costly, as well as in the capacity thereof to limit leaks.

Indeed, a proportional pressure valve needs feedback on the pressure at the output thereof to ensure proportionality between the current and the output pressure. It is therefore fitted with an output plunger, which is used to manage the pressure level. In the case of a proportional flow rate, the proportionality is simply ensured between the current and the output flow rate from the valve, and this is managed directly by opening the output orifices of the valve to a greater or lesser extent. Consequently, it does not involve an output plunger, which makes it possible to simplify the internal structure of the valve, to reduce the play between the movable parts of the valve and therefore a fortiori to reduce leaks. Furthermore, these proportional flow rate valves vibrate less than proportional pressure valves under high pressure, and this further reduces leaks. This near-perfect seal with these proportional flow rates improves the overall efficiency of the system because the high-pressure pump of the hydraulic circuit is required to operate less often, as the line pressure does not drop significantly as it does in a system with significant leaks.

Moreover, the valve works more reactively because it is not slowed down by the movement of the output plunger. The overall response time of the transmission system is therefore improved.

Finally, the absence of a plunger obviates the risk of the plunger jamming, and therefore the risk of the valve malfunctioning.

The proportional flow rate is closed-loop controlled, i.e. it is used within a closed loop in the transmission system, to enable setpoint errors to be corrected quickly. It is not simply a question of indicating the position of the clutch disks, for example, and confirming the electrical command sent to the valves, but permanently correcting the setpoint in relation to the final result, in relation to the output flow rate from the valve. Closed-loop feedback is therefore required to monitor the valves in real time. Such closed-loop control is only possible using valves with few leaks, in order to correctly, reliably and precisely control the output pressure.

With this closed-loop control, each proportional flow rate valve outputs a stable and precise pressure of between 0 and 60 bars. These valves are therefore suitable for high-pressure transmissions operating at more than 20 bars.

More specifically, the hydraulic pressure injected into the clutch exerts a pressure on a stack of rotary disks, the torque being transmitted from the drive shaft once the friction between said disks exceeds a predetermined friction threshold.

The proportional flow rate valve is configured such that adjustment is very precise when the friction threshold is detected, this being the most critical moment in the gear change: low leaks (10 mL/min maximum), high output flow rate from the valve (10 L/min for an electrical input signal of 1.5 A for example), low response time (less than 20 ms), low control volume (3.5 mL maximum).

The output flow rate from the valve must therefore be sufficient to damp the transmission system at the exact moment the engine torque is transmitted.

By controlling the different parameters mentioned above, it is possible:
to achieve more or less slipping between the disks as a function of the flexibility required for the gear change;
to adapt to all constraints of the system (component tolerance, wear, deformation, temperature increase, etc.).

Furthermore, increasing the flow rate in particular to the friction threshold and beyond makes it possible to:
reduce the overall hysteresis of the transmission system;
reduce the response time;
reduce oscillations in the clutch;
reduce leaks;
increase system efficiency.

As explained above, vibrations in the transmission are related to the volume of pressurized oil between the phase in which the clutch is deactivated/free and the phase in which the clutch is activated/engaged.

If there is a large volume of oil available upstream of the rotary disks, then the response time, damping and hysteresis are all significant. Damping makes it possible to avoid oscillations in the clutch.

To reduce the dimensions of the parts and the size of the transmission system according to the present invention, the volume of available oil is small. Consequently, the response time is short, but the risk of oscillation increases. To overcome these oscillations, the fact of quickly filling this small volume of oil to the friction threshold, and beyond to increase the force on the disks and to prevent slipping between the disks, makes it possible to damp the system at the exact moment the engine torque is transmitted.

Structurally, each proportional flow rate valve includes a movable trolley that is driven by a movable magnetic core that can be moved within a sleeve as a function of an electrical signal generated in a solenoid surrounding said movable core in response to an electrical command sent from a control unit.

Preferably, the play between said movable trolley and the sleeve of the proportional flow rate valve is between 4 and 8 microns.

The play is therefore very small, which makes it possible to considerably limit the leaks in the valve, and therefore to adjust the output pressure very accurately.

Specifically, the closed-loop control of each proportional flow rate valve is managed by a central electronic control unit that receives as input:
at least one signal from at least one sensor able to measure and output datum of the related clutch;
an output-torque setpoint dependent on the desired gear ratio;
   that compares the signal at the setpoint and outputs the difference to the control unit, which transforms the information into an electrical command to be sent to the related solenoid.

According to a first possible arrangement, the central electronic control unit receives an input signal from a torque sensor measuring the torque outputted from the clutch, said torque sensor being able to detect said friction threshold. Specifically, once a movement is measurable at the output of the clutch, it means that the torque is beginning to be transmitted and that the friction threshold has been reached.

Equally, according to a second arrangement, the central electronic control unit receives an input signal from a relative-speed sensor measuring the output speed of the clutch, said speed sensor being able to detect said friction threshold.

The relative speed is the output speed of the clutch in relation to the input speed of the clutch. Like the torque sensor, once a movement is measurable at the output of the clutch, it means that the torque is beginning to be transmitted and that the friction threshold has been reached.

According to a third possible arrangement, the central electronic control unit receives an input signal from a pressure sensor measuring the output pressure of the valve. This arrangement is used for a known clutch, i.e. a clutch in which the position of the disks is known for a given pressure. In this case, the friction threshold is reached for a pressure known in advance.

According to a fourth possible arrangement, the control electronics of the valve receive input signals from:
a pressure sensor measuring the output pressure of the valve, and
a relative-speed sensor or a torque sensor measuring the speed or the torque at the output of the clutch when the friction between the disks of the clutch is at least equal to the friction threshold, said friction threshold being detected by at least one of the sensors.

The simultaneous use of several sensors makes it possible to improve detection precision of the friction threshold, and therefore the precision of the closed-loop control.

Advantageously, said sensors are sensors already present in the transmission system that send signals to components of the vehicle other than the central electronic control unit.

Indeed, one of the advantages of the present invention is the fact that the transmission according to the invention is more compact than the transmissions in the prior art.

Reusing a sensor to perform several functions in the same vehicle contributes to this objective to reduce the size of the transmission.

For this purpose, the pressure sensor is also used to control operation of the pump (starting signal if the pressure in the line is insufficient, stop signal if the pressure rises too high) and the different valves (a given pressure must correspond to a given current).

The speed and torque sensors make it possible to determine the output speed and torque of the clutch housing for controlling the engine, the transmission of the torque and speed to the wheels, and different vehicle driving strategies (power steering, assisted braking, etc.).

In the transmissions in the prior art, in particular dual-dry-clutch transmissions using proportional flow rate valves with closed-loop control, the hydraulic circuit is outside the transmission and operates with a voluminous lever used to push the clutch disks and the position sensors added specifically for the closed-loop control. This makes the whole transmission system relatively large and costly.

In the present invention, the transmission is wet and has an internal hydraulic circuit with no lever, with the sensors already included in the system, making it compact.

Furthermore, this makes it possible for clutch disk wear to be taken into account and compensated automatically. While position sensors give different output signals as a function of disk wear, torque, pressure and relative-speed sensors are not sensitive to disk wear and return correct, stable signals.

The invention is described in greater detail below with reference to the attached figures, in which:

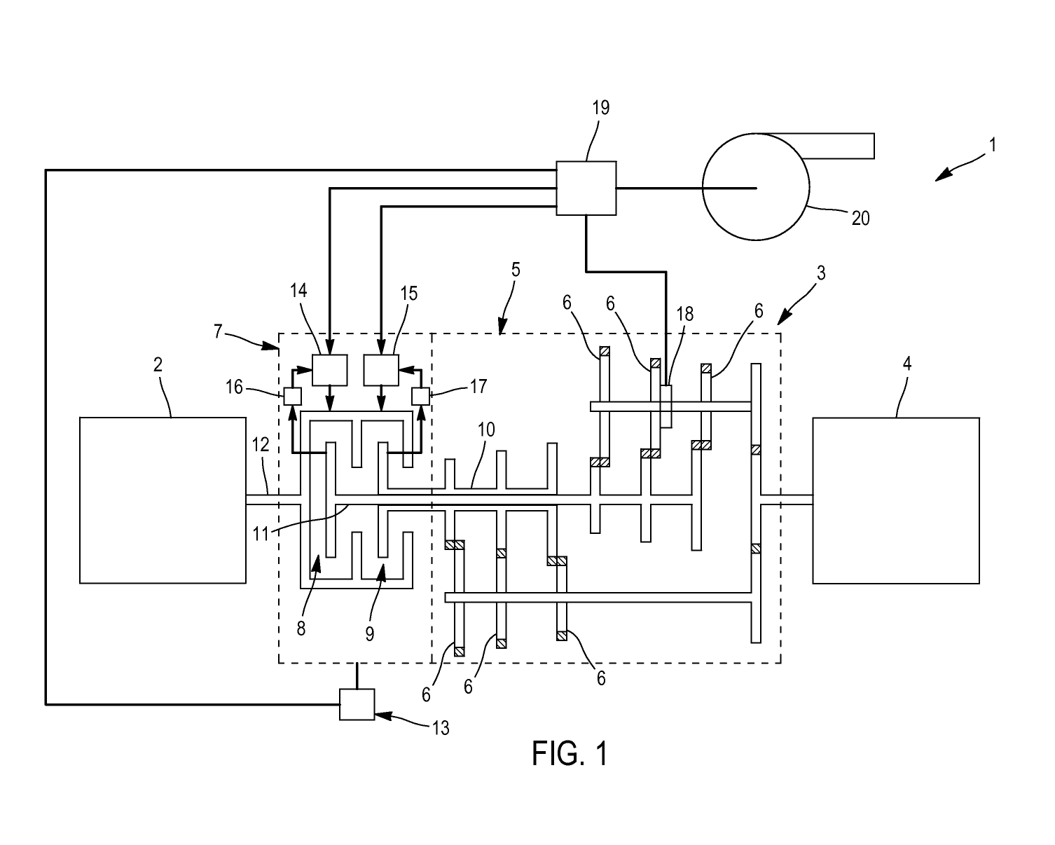

FIG. 1 is a general outline of a drive unit of a vehicle;

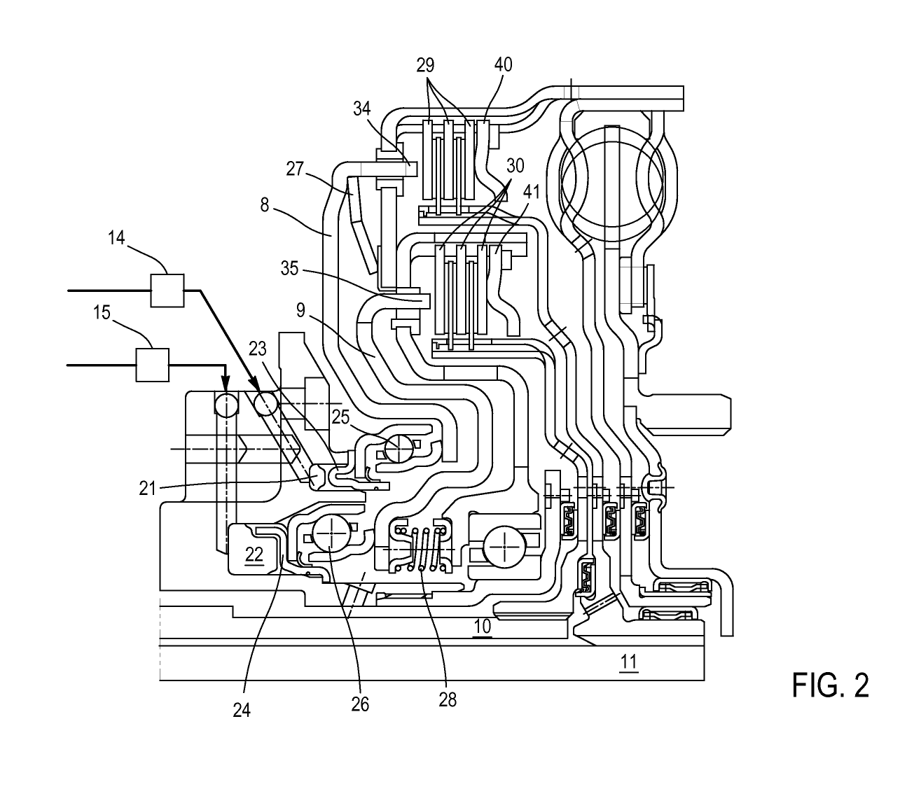

FIG. 2 is a cross section of a dual-wet-clutch transmission according to the invention;

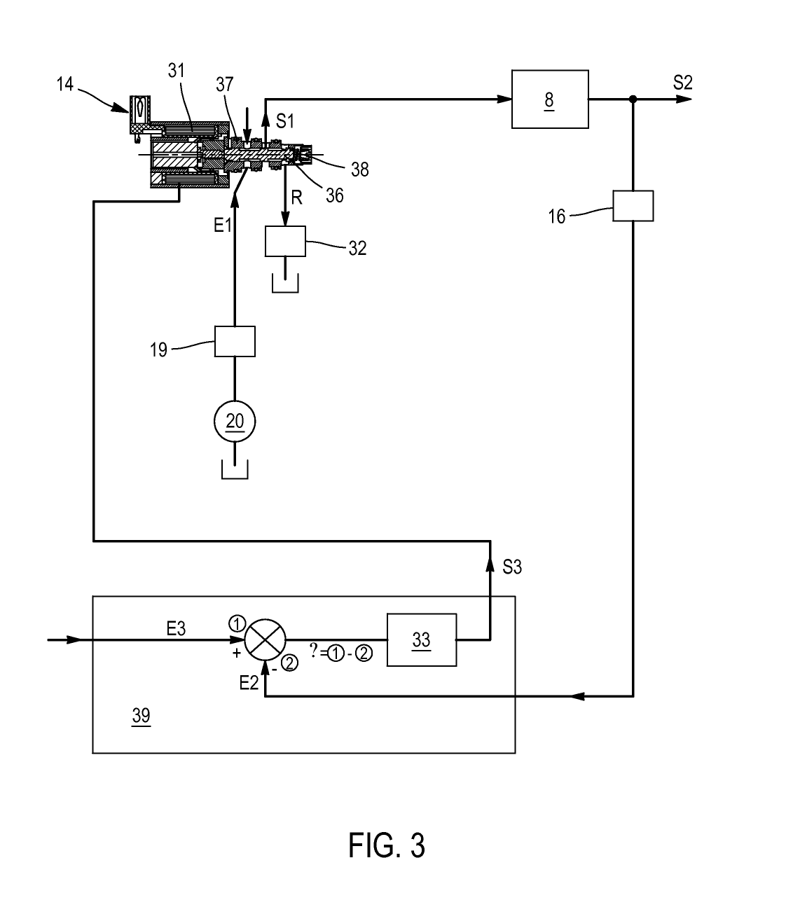

FIG. 3 illustrates the closed-loop control of a proportional flow rate valve used for a clutch in the transmission according to the invention.

FIG. 1 shows the drive unit (1) of a vehicle. This unit (1) includes:
an engine (2);
a dual-wet-clutch transmission (3);
a differential (4).

The engine (2) is arranged to produce an engine torque via a drive shaft (12) that is an input shaft in the dual-clutch transmission (3).

The transmission (3) makes it possible to change the ratios by increasing the initial rotation speed of the drive shaft (12) and transmits an output torque to the differential (4) which redirects it to the wheels (not shown) of the vehicle.

The wet transmission (3) includes:
a gear system (5) including gears (6) that can be moved between a plurality of forward ratios and a plurality of reverse ratios;
a clutch system (7) arranged between the engine (2) and the gear system (5) that is able to transfer the engine torque to the gear system (5).

The clutch system (7) includes two clutches (8, 9) able to drive the gear combinations (6) via concentric shafts (11, 10).

Each clutch (8, 9) includes a plurality of disks (29, 30) (shown in FIG. 2) that are immersed in the lubricating fluid which enables the disks (29, 30) to be cooled when they overheat. To do so, a control valve (13) controls the flow of the lubricating fluid to the clutches (8, 9) and therefore enables the flow to be increased or reduced as a function of a hydraulic signal received by said valve. This valve (13) belongs to a hydraulic circuit of the transmission (3) and may comprise a proportional flow rate valve, for example. In general, a low pressure (maximum 6 bars) is sufficient to lubricate the clutch disks (29, 30).

There are synchronizers (18) (only one shown, for the sake of clarity) in the gear system (5) and they are used to move the gears (6) to connect or disconnect them as a function of the ratio requested. These synchronizers (18) are controlled by a hydraulic signal coming from a control valve (19), which may be a proportional pressure valve.

This valve (19) controls the pressure in the hydraulic circuit, and redirects the pressurized fluid coming from a pump (20) to the different hydraulic parts of the transmission (3), specifically:
to the synchronizers (18) of the gears (6);
to the control valve (13) of the lubricating fluid;
to the proportional flow rate valves (14, 15) handling the activation and respective deactivation of the two clutches (8, 9).

The lubricating fluid circuit is separate from the clutch fluid circuit. It is in fact a highly pressurized fluid (between 20 and 60 bars) that reaches the proportional flow rate valves (14, 15). The maximum pressure is preferably 35 bars.

The pressurized fluid leaving these valves (14, 15) exerts a pressure on the disks (29, 30) that activates or deactivates the clutches (8, 9).

These valves (14, 15) are closed-loop controlled using sensors (16, 17) placed at the output of the clutches (8, 9) that detect whether the engine torque is actually being transmitted to one of the clutches (8, 9).

As shown in FIG. 2, each valve (14, 15) injects pressurized fluid to the respective clutches (8, 9) and more specifically to a zone (21, 22) of variable volume that, once filled with fluid, exerts a pressure against a seal (23, 24) of the zone (21, 22) that moves in translation and in turn exerts pressure against a rolling bearing (25, 26), then against the clutch (8, 9), opposing return means such as a Belleville washer (27) or linear spring (28). In this case, the piston (34, 35) of the clutch (8, 9) flattens the respective disks (29, 30) against a fixed plate (40, 41) such as to cause the coupling with the rotary part of the transmission (3) and to ensure that the engine torque coming from the drive shaft (12) is outputted to one of the shafts (10, 11) of the clutches (8, 9).

In this transmission configuration (3), the fluid therefore exerts an axial force via the volumes (21, 22) and the seals (23, 24). This helps to reduce overall size, ensures kinematic precision and also helps to prevent component deformation.

As these seals (23, 24) are not rotary, they also enable these zones (21, 22) to be well sealed.

Specifically, the pressure is variable in these zones (21, 22) as a function of the command previously applied to valve (14, 15). Closed-loop control ensures that the output pressure of the valve (14, 15) is relatively precise, for example between 0 and 35 bars when the maximum pressure of the fluid reaching the valve (14) is 35 bars.

As shown in FIG. 3, the valve (14) conventionally includes a moveable trolley (36) surrounded by a sleeve (37). The trolley (36) is driven by a movable magnetic core activated by a solenoid (31) and it moves against a spring (38) to open the output orifices (R and S1) to a greater or lesser extent.

At the input (E1), the valve (14) receives the pressurized fluid from the pump (20) via the control valve (19). Depending on the movement of the trolley (36), either the valve (14) sends the unused fluid via the output (R) to a tank (32), or sends the fluid, at a very precise pressure, via the output (S1), to the clutch (8), which transmits an output torque (S2) to the gear system (5). At least one sensor (16) placed at the output of the clutch (8) enables this torque transmission to be detected.

More specifically, a pressure sensor may be used to measure the pressure in the zone (21), and/or a torque sensor may be used to measure the output torque of the clutch (8), and/or a relative-speed sensor may be used to measure the relative speed of the clutch disks (29) in relation to one another.

The purpose of these sensors (16) is to detect the friction threshold between the disks (29), i.e. the moment at which the friction between the disks (29) is sufficient for the engine torque to start being transmitted to the shaft (10). Specifically, once an output movement of the transmission (3) is measurable, it means that the friction threshold has been reached. The sensors (16) then send data to a central electronic control unit (39) that is part of the overall control of the system of the vehicle that controls all of the valves, sensors and movements of the transmission system.

The valve (15) is therefore also controlled in the same way by this central electronic control unit (39).

This central electronic control unit (39) therefore receives data from the sensor as an input (E2) along with a setpoint (E3) that corresponds for example to the desired output torque. It then compares the data (E2) from the sensor (16) with the setpoint (E3), and the difference (E3-E2) is sent to a control unit (33) that corrects the difference and sends an output electrical command (S3) to the solenoid (31) of the valve (14) to regulate the fluid flow rate and to control the output pressure of the valve (14).

Once the friction threshold is detected by the sensors (16), the central electronic control unit (39) ensures that the flow rate level increases considerably at the output of the valve (14) such as to damp the transmission system (3) at the exact moment the engine torque is transmitted.

The invention above is described using preferable examples which should not be understood to be exhaustive. Variants and modifications in form falling within the scope of the attached claims are part of the invention.

1. A dual-wet-clutch transmission (3) for a vehicle gearbox, said dual-clutch transmission (3) being coupled to a drive shaft (12) and being able to receive the torque from the drive shaft (12), including:
a first wet clutch (8) that is movable between a free position and an engaged position with the drive shaft (12) to actuate a first gear arrangement (6) in the gearbox;
a second wet clutch (9) that is movable between a free position and an engaged position with the drive shaft (12) to actuate a second gear arrangement (6) in the gearbox;
a hydraulic circuit fed by a pump (20) supplying the pressurized fluid;
means for controlling the movement of the clutches (8, 9), belonging to the hydraulic circuit;
wherein said means for controlling the movement of the clutches (8, 9) include a proportional flow rate valve (14, 15) for each clutch (8, 9) providing at the output (S1) a hydraulic pressure injected into the clutch (8, 9) against a return force exerted on the clutch (8, 9) by spring means (27, 28), said proportional flow rate valve (14, 15) being closed-loop controlled to adjust the output pressure (S1).

2. The dual-wet-clutch transmission (3) as set forth in claim 1, wherein each proportional flow rate valve (14, 15) provides at the output (S1) a stable pressure between 0 and 60 bars.

3. The dual-wet-clutch transmission (3) as set forth in claim 2, wherein the hydraulic pressure injected into the clutch (8, 9) exerts a pressure on a stack of rotary disks (29, 30), the torque being transmitted from the drive shaft (12) once the friction between said disks (29, 30) exceeds a predetermined friction threshold.

4. The dual-wet-clutch transmission (3) set forth in claim 1, wherein each proportional flow rate valve (14, 15) includes a movable trolley (36) that is driven by a movable magnetic core that can be moved within a sleeve (37) as a function of an electrical signal generated in a solenoid (31) surrounding said movable core in response to an electrical command (S3) sent from a control unit (33).

5. The dual-wet-clutch transmission (3) set forth in claim 1, wherein, when the friction threshold is detected, the flow rate at the output (S1) of the proportional flow rate valve (14, 15) is 10 L/mn for an input electrical signal of 1.5 A, the response time of the valve (14, 15) being less than 20 ms.

6. The dual-wet-clutch transmission (3) as set forth in claim 4, wherein the play between said movable trolley (36) and the sleeve (37) of the proportional flow rate valve (14, 15) is between 4 and 8 microns.

7. The dual-wet-clutch transmission (3) as claimed in one of the preceding claims set forth in claim 1, wherein the closed-loop control of each proportional flow rate valve (14, 15) is managed by a central electronic control unit (39) that receives as input:
at least one signal (E2) from at least one sensor (16, 17) that is able to measure a datum at the output of the respective clutch (8, 9);
a speed-change setpoint (E1);
that compares the signal (E2) with the setpoint (E1) and outputs the difference (ε) to the control unit (33) which transforms the information into an electrical command (S3) intended for the respective solenoid (31).

8. The dual-wet-clutch transmission (3) set forth in claim 7, wherein the central electronic control unit (39) receives an input signal (E2) from a torque sensor (16, 17) measuring the torque at the output (S2) of the clutch (8, 9), said torque sensor (16, 17) being able to detect said friction threshold.

9. The dual-wet-clutch transmission (3) set forth in claim 7, wherein the central electronic control unit (39) receives an input signal (E2) from a relative-speed sensor (16, 17) measuring the speed at the output (S2) of the clutch (8, 9), said speed sensor (16, 17) being able to detect said friction threshold.

10. The dual-wet-clutch transmission (3) as set forth in claim 7, wherein the central electronic control unit (39) receives an input signal (E2) from a pressure sensor (16, 17) measuring the pressure at the output (S1) of the valve (14, 15).

11. The dual-wet-clutch transmission (3) as set forth in claim 7, wherein the central electronic control unit (39) receives input signals (E2) from:
a pressure sensor (16, 17) measuring the pressure at the output (S1) of the valve (14, 15), and
a relative-speed sensor (16, 17) or a torque sensor (16, 17) measuring the speed or the torque at the output (S2) of the clutch (8, 9) when the friction between the disks (29, 30) of the clutch (8, 9) is at least equal to the friction threshold,
said friction threshold being detected by at least one of the sensors (16, 17).

12. The dual-wet-clutch transmission (3) as set forth in claim 7, wherein said sensors (16, 17) are sensors already present in the transmission system (3) that send signals to components of the vehicle other than the central electronic control unit (39).
